(19) United States
(12) Patent Application Publication
(10) Pub. No.: US 2021/0367702 A1
(43) Pub. Date: Nov. 25, 2021

(54) DEVICES AND METHODS FOR LINK ADAPTATION

(71) Applicant: Intel Corporation, Santa Clara, CA (US)

(72) Inventors: Xiaoran FANG, Shanghai (CN); Shoujiang MA, Shanghai (CN); Hujun YIN, Saratoga, CA (US); Rongzhen YANG, Shanghai (CN)

(21) Appl. No.: 17/040,546

(22) PCT Filed: Jul. 12, 2018
(86) PCT No.: PCT/CN2018/095412

§ 371 Date: Sep. 23, 2020

(51) Int. Cl. H04L 1/00; H04B 7/0413; H04B 17/336; G06N 3/02

(52) U.S. Cl. CPC H04L 1/0003; G06N 3/02; H04B 17/336; H04B 7/0413

(57) ABSTRACT

Devices and methods for determining a Modulation and Coding Scheme (MCS) index to provide in a feedback to a network, including providing a plurality of inputs, wherein a first subset of the plurality of inputs includes one or more resource block inputs each corresponding to a resource block from a post-signal-to-interference-noise-ratio (post-SINR), and wherein a second subset of the plurality of inputs includes MCS information; determining a plurality of outputs based on the plurality of inputs, wherein each of the plurality of outputs corresponds to a respective MCS index; and selecting an MCS index from the plurality of outputs to provide in the feedback to the network.

### CROSS-REFERENCE TO RELATED APPLICATIONS

This application is a national stage entry according to 35 U.S.C. § 371 of PCT application No. PCT/CN2018/095412 filed on Jul. 12, 2018, the contents of which are incorporated by reference herein in their entirety.

### TECHNICAL FIELD

Various aspects relate generally to wireless communications.

### BACKGROUND

In the next generation of wireless technology study and development, machine learning technologies incorporated in the wireless communication protocol stack and network will be able to enable artificial intelligence for boosting the network efficiency and throughput. Link adaptation has been studied in the field of Wi-Fi communications using various machine learning methods, such as K-NN (K-Nearest Neighbor) and SVM (Support Vector Machine), among others. These methods have shown significant performance gains by using a spectrum efficiency calculation based link level simulation. However, these methods have a high computational complexity, and may not be suitable for implementation in wireless technologies with more stringent latency requirements, e.g. in LTE baseband processing.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 shows an exemplary radio communication network according to some aspects;

FIG. 2 shows an internal configuration of terminal device according to some aspects;

FIG. 3 shows an exemplary configuration of signal acquisition and processing circuitry according to some aspects;

FIG. 4 shows an exemplary internal configuration of a network access node in some aspects;

FIG. 5 shows an exemplary configuration of a network access node interfacing with core network according to some aspects;

FIG. 6 shows a deep neural network (DNN) for PDSCH link adaptation according to some aspects;

FIG. 7 shows a DNN scheme for PDSCH link adaptation according to some aspects;

FIG. 8 shows a diagram illustrating the simplification of the DNN structure in some aspects;

FIG. 9 shows a flowchart illustrating a DNN link adaptation process in some aspects;

FIG. 10 shows a graph plotting the throughput vs the Signal-to-Noise Ratio comparing the results of the DNN implementation of this disclosure with conventional MIESM methods according to some aspects;

FIG. 11 shows a graph plotting the Packet Error Rate (PER) vs. the SNR comparing the results of the DNN implementation of this disclosure with conventional MIESM methods in some aspects;

FIG. 12 shows a cumulative distribution function (CDF) curve of SINR distribution in some aspects;

FIG. 13 shows an exemplary internal configuration of controller according to some aspects;

FIG. 14 shows a flowchart describing a link adaptation process according to some aspects;

FIG. 15 shows a flowchart describing a link adaptation process according to some aspects; and

FIG. 16 shows a circuit configuration of a terminal device according to some aspects.

### DESCRIPTION

The following detailed description refers to the accompanying drawings that show, by way of illustration, specific details and aspects in which the disclosure may be practiced.

The word “exemplary” is used herein to mean “serving as an example, instance, or illustration”. Any aspect or design described herein as “exemplary” is not necessarily to be construed as preferred or advantageous over other aspects or designs.

The words “plurality” and “multiple” in the description or the claims expressly refer to a quantity greater than one. The terms “group (of)”, “set (of)”, “collection (of)”, “series (of)”, “sequence (of)”, “grouping (of)”, etc., and the like in the description or in the claims refer to a quantity equal to or greater than one, i.e. one or more. Any term expressed in plural form that does not expressly state “plurality” or “multiple” likewise refers to a quantity equal to or greater than one. The terms “proper subset”, “reduced subset”, and “lesser subset” refer to a subset of a set that is not equal to the set, i.e. a subset of a set that contains less elements than the set.

Any vector and/or matrix notation utilized herein is exemplary in nature and is employed solely for purposes of explanation. Accordingly, aspects of this disclosure accompanied by vector and/or matrix notation are not limited to being implemented solely using vectors and/or matrices, and that the associated processes and computations may be equivalently performed with respect to sets, sequences, groups, etc., of data, observations, information, signals, samples, symbols, elements, etc.

As used herein, “memory” are understood as a non-transitory computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, etc., or any combination thereof. Furthermore, registers, shift registers, processor registers, data buffers, etc., are also embraced herein by the term memory. A single component referred to as “memory” or “a memory” may be composed of more than one different type of memory, and thus may refer to a collective component including one or more types of memory. Any single memory component may be separated into multiple collectively equivalent memory components, and vice versa. Furthermore, while memory may be depicted as separate from one or more other components (such as in the drawings), memory may also be integrated with other components, such as on a common integrated chip or a controller with an embedded memory.

The term “software” refers to any type of executable instruction, including firmware.

The term “terminal device” utilized herein refers to user-side devices (both portable and fixed) that can connect to a core network and/or external data networks via a radio access network. “Terminal device” can include any mobile or immobile wireless communication device, including User Equipment (UEs), Mobile Stations (MSs), Stations (STAs), cellular phones, tablets, laptops, personal computers, wearables, multimedia playback and other handheld or body-mounted electronic devices, consumer/home/office/commercial appliances, vehicles, and any other electronic device capable of user-side wireless communications. Without loss of generality, in some cases terminal devices can also include application-layer components, such as application processors or other general processing components that are directed to functionality other than wireless communications. Terminal devices can optionally support wired communications in addition to wireless communications. Furthermore, terminal devices can include vehicular communication devices that function as terminal devices.

The term “network access node” as utilized herein refers to a network-side device that provides a radio access network with which terminal devices can connect and exchange information with a core network and/or external data networks through the network access node. “Network access nodes” can include any type of base station or access point, including macro base stations, micro base stations, NodeBs, evolved NodeBs (eNBs), Home base stations, Remote Radio Heads (RRHs), relay points, Wi-Fi/WLAN Access Points (APs), Bluetooth master devices, DSRC RSUs, terminal devices acting as network access nodes, and any other electronic device capable of network-side wireless communications, including both immobile and mobile devices (e.g., vehicular network access nodes, moving cells, and other movable network access nodes). As used herein, a “cell” in the context of telecommunications may be understood as a sector served by a network access node. Accordingly, a cell may be a set of geographically co-located antennas that correspond to a particular sectorization of a network access node. A network access node can thus serve one or more cells (or sectors), where the cells are characterized by distinct communication channels. Furthermore, the term “cell” may be utilized to refer to any of a macrocell, microcell, femtocell, picocell, etc. Certain communication devices can act as both terminal devices and network access nodes, such as a terminal device that provides network connectivity for other terminal devices.

Various aspects of this disclosure may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the following examples. Various exemplary radio communication technologies that the aspects described herein may utilize include, but are not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18 (3rd Generation Partnership Project Release 18), 3GPP 5G, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication arrangement/Extended Total Access Communication arrangement (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication arrangements such as Intelligent-Transport-Systems, and other existing, developing, or future radio communication technologies. As used herein, a first radio communication technology may be different from a second radio communication technology if the first and second radio communication technologies are based on different communication standards.

Aspects described herein may use such radio communication technologies according to various spectrum management schemes, including, but not limited to, dedicated licensed spectrum, unlicensed spectrum, (licensed) shared spectrum (such as LSA, “Licensed Shared Access,” in 2.3-2.4 GHz, 3.4-3.6 GHz, 3.6-3.8 GHz and further frequencies and SAS, “Spectrum Access System,” in 3.55-3.7 GHz and further frequencies), and may be use various spectrum bands including, but not limited to, IMT (International Mobile Telecommunications) spectrum (including 450-470 MHz, 790-960 MHz, 1710-2025 MHz, 2110-2200 MHz, 2300-2400 MHz, 2500-2690 MHz, 698-790 MHz, 610-790 MHz, 3400-3600 MHz, etc., where some bands may be limited to specific region(s) and/or countries), IMT-advanced spectrum, IMT-2020 spectrum (expected to include 3600-3800 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 64-71 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), the 70.2 GHz-71 GHz band, any band between 65.88 GHz and 71 GHz, bands currently allocated to automotive radar applications such as 76-81 GHz, and future bands including 94-300 GHz and above. Furthermore, aspects described herein can also employ radio communication technologies on a secondary basis on bands such as the TV White Space bands (typically below 790 MHz) where in particular the 400 MHz and 700 MHz bands are prospective candidates. Besides cellular applications, specific applications for vertical markets may be addressed such as PMSE (Program Making and Special Events), medical, health, surgery, automotive, low-latency, drones, etc. applications. Furthermore, aspects described herein may also use radio communication technologies with a hierarchical application, such as by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc. Aspects described herein can also use radio communication technologies with different Single Carrier or OFDM flavors (CP-OFDM, SC-FDMA, SC-OFDM, filter bank-based multicarrier (FBMC), OFDMA, etc.) and in particular 3GPP NR (New Radio), which can include allocating the OFDM carrier data bit vectors to the corresponding symbol resources.

For purposes of this disclosure, radio communication technologies may be classified as one of a Short Range radio communication technology or Cellular Wide Area radio communication technology. Short Range radio communication technologies may include Bluetooth, WLAN (e.g., according to any IEEE 802.11 standard), and other similar radio communication technologies. Cellular Wide Area radio communication technologies may include Global System for Mobile Communications (GSM), Code Division Multiple Access 2000 (CDMA2000), Universal Mobile Telecommunications System (UMTS), Long Term Evolution (LTE), General Packet Radio Service (GPRS), Evolution-Data Optimized (EV-DO), Enhanced Data Rates for GSM Evolution (EDGE), High Speed Packet Access (HSPA; including High Speed Downlink Packet Access (HSDPA), High Speed Uplink Packet Access (HSUPA), HSDPA Plus (HSDPA+), and HSUPA Plus (HSUPA+)), Worldwide Interoperability for Microwave Access (WiMax) (e.g., according to an IEEE 802.16 radio communication standard, e.g., WiMax fixed or WiMax mobile), etc., and other similar radio communication technologies. Cellular Wide Area radio communication technologies also include “small cells” of such technologies, such as microcells, femtocells, and picocells. Cellular Wide Area radio communication technologies may be generally referred to herein as “cellular” communication technologies.

The terms “radio communication network” and “wireless network” as utilized herein encompasses both an access section of a network (e.g., a radio access network (RAN) section) and a core section of a network (e.g., a core network section). The term “radio idle mode” or “radio idle state” used herein in reference to a terminal device refers to a radio control state in which the terminal device is not allocated at least one dedicated communication channel of a mobile communication network. The term “radio connected mode” or “radio connected state” used in reference to a terminal device refers to a radio control state in which the terminal device is allocated at least one dedicated uplink communication channel of a radio communication network.

Unless explicitly specified, the term “transmit” encompasses both direct (point-to-point) and indirect transmission (via one or more intermediary points). Similarly, the term “receive” encompasses both direct and indirect reception. Furthermore, the terms “transmit”, “receive”, “communicate”, and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e. unidirectional or bidirectional communication in one or both of the incoming and outgoing directions. The term “calculate” encompass both ‘direct’ calculations via a mathematical expression/formula/relationship and ‘indirect’ calculations via lookup or hash tables and other array indexing or searching operations.

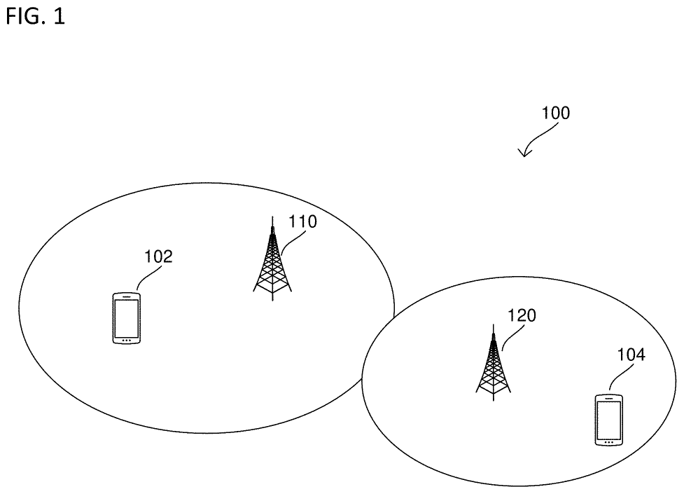

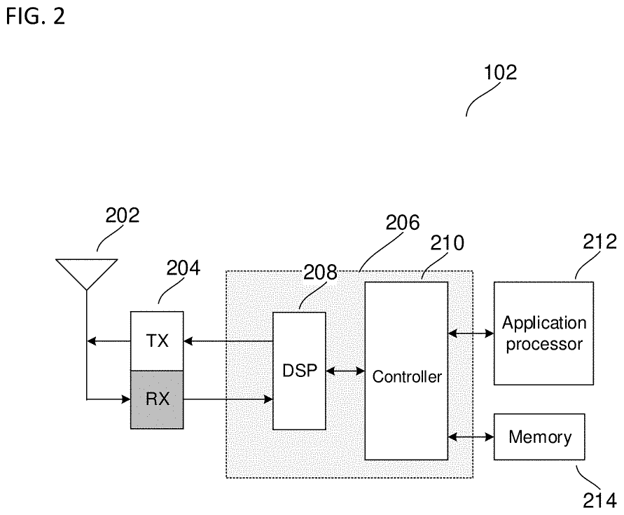

FIGS. 1 and 2 depict an exemplary network and device architecture for wireless communications, respectively. In particular, FIG. 1 shows an exemplary radio communication network 100 according to some aspects, which may include terminal devices 102 and 104 and network access nodes 110 and 120. Radio communication network 100 may communicate with terminal devices 102 and 104 via network access nodes 110 and 120 over a radio access network. Although certain examples described herein may refer to a particular radio access network context (e.g., LTE, UMTS, GSM, other 3rd Generation Partnership Project (3GPP) networks, WLAN/WiFi, Bluetooth, 5G, mmWave, etc.), these examples are demonstrative and may therefore be readily applied to any other type or configuration of radio access network. The number of network access nodes and terminal devices in radio communication network 100 is exemplary and is scalable to any amount.

In an exemplary cellular context, network access nodes 110 and 120 may be base stations (e.g., eNodeBs, NodeBs, Base Transceiver Stations (BTSs), or any other type of base station), while terminal devices 102 and 104 may be cellular terminal devices (e.g., Mobile Stations (MSs), User Equipment (UEs), or any type of cellular terminal device). Network access nodes 110 and 120 may therefore interface (e.g., via backhaul interfaces) with a cellular core network such as an Evolved Packet Core (EPC, for LTE), Core Network (CN, for UMTS), or other cellular core networks, which may also be considered part of radio communication network 100. The cellular core network may interface with one or more external data networks. In an exemplary short-range context, network access node 110 and 120 may be access points (APs, e.g., WLAN or WiFi APs), while terminal device 102 and 104 may be short range terminal devices (e.g., stations (STAs)). Network access nodes 110 and 120 may interface (e.g., via an internal or external router) with one or more external data networks.

Network access nodes 110 and 120 (and, optionally, other network access nodes of radio communication network 100 not explicitly shown in FIG. 1) may accordingly provide a radio access network to terminal devices 102 and 104 (and, optionally, other terminal devices of radio communication network 100 not explicitly shown in FIG. 1). In an exemplary cellular context, the radio access network provided by network access nodes 110 and 120 may enable terminal devices 102 and 104 to wirelessly access the core network via radio communications. The core network may provide switching, routing, and transmission, for traffic data related to terminal devices 102 and 104, and may further provide access to various internal data networks (e.g., control nodes, routing nodes that transfer information between other terminal devices on radio communication network 100, etc.) and external data networks (e.g., data networks providing voice, text, multimedia (audio, video, image), and other Internet and application data). In an exemplary short-range context, the radio access network provided by network access nodes 110 and 120 may provide access to internal data networks (e.g., for transferring data between terminal devices connected to radio communication network 100) and external data networks (e.g., data networks providing voice, text, multimedia (audio, video, image), and other Internet and application data).

The radio access network and core network (if applicable, such as for a cellular context) of radio communication network 100 may be governed by communication protocols that can vary depending on the specifics of radio communication network 100. Such communication protocols may define the scheduling, formatting, and routing of both user and control data traffic through radio communication network 100, which includes the transmission and reception of such data through both the radio access and core network domains of radio communication network 100. Accordingly, terminal devices 102 and 104 and network access nodes 110 and 120 may follow the defined communication protocols to transmit and receive data over the radio access network domain of radio communication network 100, while the core network may follow the defined communication protocols to route data within and outside of the core network. Exemplary communication protocols include LTE, UMTS, GSM, WiMAX, Bluetooth, WiFi, mmWave, etc., any of which may be applicable to radio communication network 100.

FIG. 2 shows an internal configuration of terminal device 102 according to some aspects, which may include an antenna system 202, radio frequency (RF) transceiver 204, baseband modem 206 (including digital signal processor 208 and protocol controller 210), application processor 212, and memory 214. Although not explicitly shown in FIG. 2, in some aspects terminal device 102 may include one or more additional hardware and/or software components, such as processors/microprocessors, controllers/microcontrollers, other specialty or generic hardware/processors/circuits, peripheral device(s), memory, power supply, external device interface(s), subscriber identity module(s) (SIMs), user input/output devices (display(s), keypad(s), touchscreen(s), speaker(s), external button(s), camera(s), microphone(s), etc.), or other related components.

Terminal device 102 may transmit and receive radio signals on one or more radio access networks. Baseband modem 206 may direct such communication functionality of terminal device 102 according to the communication protocols associated with each radio access network, and may execute control over antenna system 202 and RF transceiver 204 to transmit and receive radio signals according to the formatting and scheduling parameters defined by each communication protocol. Although various practical designs may include separate communication components for each supported radio communication technology (e.g., a separate antenna, RF transceiver, digital signal processor, and controller), for purposes of conciseness the configuration of terminal device 102 shown in FIG. 2 depicts only a single instance of such components.

Terminal device 102 may transmit and receive wireless signals with antenna system 202, which may be a single antenna or an antenna array that includes multiple antennas. In some aspects, antenna system 202 may additionally include analog antenna combination and/or beamforming circuitry. In the receive (RX) path, RF transceiver 204 may receive analog radio frequency signals from antenna system 202 and perform analog and digital RF front-end processing on the analog radio frequency signals to produce digital baseband samples (e.g., In-Phase/Quadrature (IQ) samples) to provide to baseband modem 206. RF transceiver 204 may include analog and digital reception components including amplifiers (e.g., Low Noise Amplifiers (LNAs)), filters, RF demodulators (e.g., RF IQ demodulators)), and analog-to-digital converters (ADCs), which RF transceiver 204 may utilize to convert the received radio frequency signals to digital baseband samples. In the transmit (TX) path, RF transceiver 204 may receive digital baseband samples from baseband modem 206 and perform analog and digital RF front-end processing on the digital baseband samples to produce analog radio frequency signals to provide to antenna system 202 for wireless transmission. RF transceiver 204 may thus include analog and digital transmission components including amplifiers (e.g., Power Amplifiers (PAs), filters, RF modulators (e.g., RF IQ modulators), and digital-to-analog converters (DACs), which RF transceiver 204 may utilize to mix the digital baseband samples received from baseband modem 206 and produce the analog radio frequency signals for wireless transmission by antenna system 202. In some aspects baseband modem 206 may control the radio transmission and reception of RF transceiver 204, including specifying the transmit and receive radio frequencies for operation of RF transceiver 204.

As shown in FIG. 2, baseband modem 206 may include digital signal processor 208, which may perform physical layer (PHY, Layer 1) transmission and reception processing, in the transmit path, to prepare outgoing transmit data provided by protocol controller 210 for transmission via RF transceiver 204, and, in the receive path, to prepare incoming received data provided by RF transceiver 204 for processing by protocol controller 210. Digital signal processor 208 may be configured to perform one or more of error detection, forward error correction encoding/decoding, channel coding and interleaving, channel modulation/demodulation, physical channel mapping, radio measurement and search, frequency and time synchronization, antenna diversity processing, power control and weighting, rate matching/de-matching, retransmission processing, interference cancelation, and any other physical layer processing functions. Digital signal processor 208 may be structurally realized as hardware components (e.g., as one or more digitally-configured hardware circuits or FPGAs), software-defined components (e.g., one or more processors configured to execute program code defining arithmetic, control, and I/O instructions (e.g., software and/or firmware) stored in a non-transitory computer-readable storage medium), or as a combination of hardware and software components. In some aspects, digital signal processor 208 may include one or more processors configured to retrieve and execute program code that defines control and processing logic for physical layer processing operations. In some aspects, digital signal processor 208 may execute processing functions with software via the execution of executable instructions. In some aspects, digital signal processor 208 may include one or more dedicated hardware circuits (e.g., ASICs, FPGAs, and other hardware) that are digitally configured to specific execute processing functions, where the one or more processors of digital signal processor 208 may offload certain processing tasks to these dedicated hardware circuits, which are known as hardware accelerators. Exemplary hardware accelerators can include Fast Fourier Transform (FFT) circuits and encoder/decoder circuits. In some aspects, the processor and hardware accelerator components of digital signal processor 208 may be realized as a coupled integrated circuit.

Terminal device 102 may be configured to operate according to one or more radio communication technologies. Digital signal processor 208 may be responsible for lower-layer processing functions (e.g., Layer 1/PHY) of the radio communication technologies, while protocol controller 210 may be responsible for upper-layer protocol stack functions (e.g., Data Link Layer/Layer 2 and/or Network Layer/Layer 3). Protocol controller 210 may thus be responsible for controlling the radio communication components of terminal device 102 (antenna system 202, RF transceiver 204, and digital signal processor 208) in accordance with the communication protocols of each supported radio communication technology, and accordingly may represent the Access Stratum and Non-Access Stratum (NAS) (also encompassing Layer 2 and Layer 3) of each supported radio communication technology. Protocol controller 210 may be structurally embodied as a processor configured to execute protocol stack software (retrieved from a controller memory) and subsequently control the radio communication components of terminal device 102 to transmit and receive communication signals in accordance with the corresponding protocol stack control logic defined in the protocol stack software. Protocol controller 210 may include one or more processors configured to retrieve and execute program code that defines the upper-layer protocol stack logic for one or more radio communication technologies, which can include Data Link Layer/Layer 2 and Network Layer/Layer 3 functions. Protocol controller 210 may be configured to perform both user-plane and control-plane functions to facilitate the transfer of application layer data to and from radio terminal device 102 according to the specific protocols of the supported radio communication technology. User-plane functions can include header compression and encapsulation, security, error checking and correction, channel multiplexing, scheduling and priority, while control-plane functions may include setup and maintenance of radio bearers. The program code retrieved and executed by protocol controller 210 may include executable instructions that define the logic of such functions.

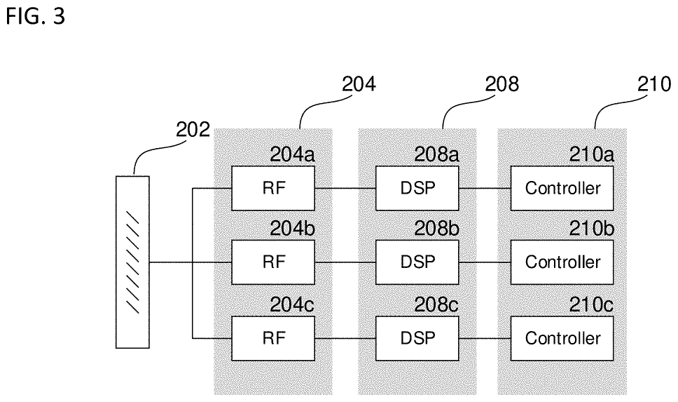

In some aspects, terminal device 102 may be configured to transmit and receive data according to multiple radio communication technologies. Accordingly, in some aspects one or more of antenna system 202, RF transceiver 204, digital signal processor 208, and protocol controller 210 may include separate components or instances dedicated to different radio communication technologies and/or unified components that are shared between different radio communication technologies. For example, in some aspects protocol controller 210 may be configured to execute multiple protocol stacks, each dedicated to a different radio communication technology and either at the same processor or different processors. In some aspects, digital signal processor 208 may include separate processors and/or hardware accelerators that are dedicated to different respective radio communication technologies, and/or one or more processors and/or hardware accelerators that are shared between multiple radio communication technologies. In some aspects, RF transceiver 204 may include separate RF circuitry sections dedicated to different respective radio communication technologies, and/or RF circuitry sections shared between multiple radio communication technologies. In some aspects, antenna system 202 may include separate antennas dedicated to different respective radio communication technologies, and/or antennas shared between multiple radio communication technologies. Accordingly, while antenna system 202, RF transceiver 204, digital signal processor 208, and protocol controller 210 are shown as individual components in FI, in some aspects antenna system 202, RF transceiver 204, digital signal processor 208, and/or protocol controller 210 can encompass separate components dedicated to different radio communication technologies. Accordingly, while antenna system 202, RF transceiver 204, digital signal processor 208, and controller 210 are shown as individual components in FIG. 3, in some aspects antenna system 202, RF transceiver 204, digital signal processor 208, and/or controller 210 can encompass separate components dedicated to different radio communication technologies.

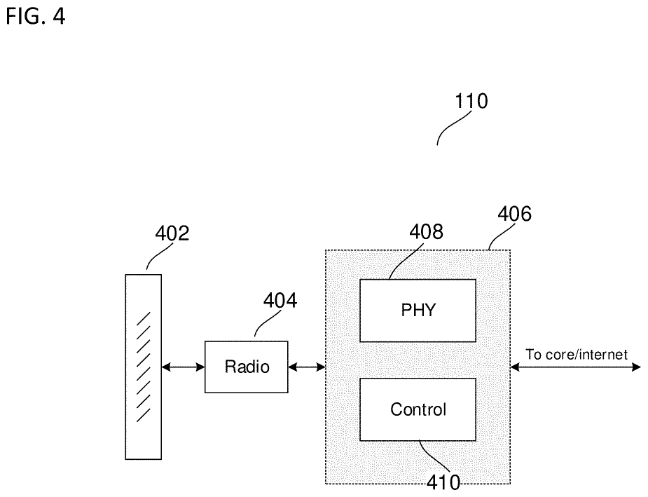

FIG. 3 shows an example in which RF transceiver 204 includes RF transceiver 204a for a first radio communication technology, RF transceiver 204b for a second radio communication technology, and RF transceiver 204c for a third radio communication technology. Likewise, digital signal processor 208 includes digital signal processor 208a for the first radio communication technology, digital signal processor 208b for the second radio communication technology, and digital signal processor 208c for the third radio communication technology. Similarly, controller 210 may include controller 210a for the first radio communication technology, controller 210b for the second radio communication technology, and controller 210c for the third radio communication technology. RF transceiver 204a, digital signal processor 208a, and controller 210a thus form a communication arrangement (e.g., the hardware and software components dedicated to a particular radio communication technology) for the first radio communication technology, RF transceiver 204b, digital signal processor 208b, and controller 210b thus form a communication arrangement for the second radio communication technology, and RF transceiver 204c, digital signal processor 208c, and controller 210c thus form a communication arrangement for the third radio communication technology. While depicted as being logically separate in FIG. 4, any components of the communication arrangements may be integrated into a common component.

Terminal device 102 may also include application processor 212 and memory 214. Application processor 212 may be a CPU, and may be configured to handle the layers above the protocol stack, including the transport and application layers. Application processor 212 may be configured to execute various applications and/or programs of terminal device 102 at an application layer of terminal device 102, such as an operating system (OS), a user interface (UI) for supporting user interaction with terminal device 102, and/or various user applications. The application processor may interface with baseband modem 206 and act as a source (in the transmit path) and a sink (in the receive path) for user data, such as voice data, audio/video/image data, messaging data, application data, basic Internet/web access data, etc. In the transmit path, protocol controller 210 may therefore receive and process outgoing data provided by application processor 212 according to the layer-specific functions of the protocol stack, and provide the resulting data to digital signal processor 208. Digital signal processor 208 may then perform physical layer processing on the received data to produce digital baseband samples, which digital signal processor may provide to RF transceiver 204. RF transceiver 204 may then process the digital baseband samples to convert the digital baseband samples to analog RF signals, which RF transceiver 204 may wirelessly transmit via antenna system 202. In the receive path, RF transceiver 204 may receive analog RF signals from antenna system 202 and process the analog RF signals to obtain digital baseband samples. RF transceiver 204 may provide the digital baseband samples to digital signal processor 208, which may perform physical layer processing on the digital baseband samples. Digital signal processor 208 may then provide the resulting data to protocol controller 210, which may process the resulting data according to the layer-specific functions of the protocol stack and provide the resulting incoming data to application processor 212. Application processor 212 may then handle the incoming data at the application layer, which can include execution of one or more application programs with the data and/or presentation of the data to a user via a user interface.

Memory 214 may embody a memory component of terminal device 102, such as a hard drive or another such permanent memory device. Although not explicitly depicted in FIG. 2, the various other components of terminal device 102 shown in FIG. 2 may additionally each include integrated permanent and non-permanent memory components, such as for storing software program code, buffering data, etc.

In accordance with some radio communication networks, terminal devices 102 and 104 may execute mobility procedures to connect to, disconnect from, and switch between available network access nodes of the radio access network of radio communication network 100. As each network access node of radio communication network 100 may have a specific coverage area, terminal devices 102 and 104 may be configured to select and re-select between the available network access nodes in order to maintain a strong radio access connection with the radio access network of radio communication network 100. For example, terminal device 102 may establish a radio access connection with network access node 110 while terminal device 104 may establish a radio access connection with network access node 112. In the event that the current radio access connection degrades, terminal devices 102 or 104 may seek a new radio access connection with another network access node of radio communication network 100; for example, terminal device 104 may move from the coverage area of network access node 112 into the coverage area of network access node 110. As a result, the radio access connection with network access node 112 may degrade, which terminal device 104 may detect via radio measurements such as signal strength or signal quality measurements of network access node 112. Depending on the mobility procedures defined in the appropriate network protocols for radio communication network 100, terminal device 104 may seek a new radio access connection (which may be, for example, triggered at terminal device 104 or by the radio access network), such as by performing radio measurements on neighboring network access nodes to determine whether any neighboring network access nodes can provide a suitable radio access connection. As terminal device 104 may have moved into the coverage area of network access node 110, terminal device 104 may identify network access node 110 (which may be selected by terminal device 104 or selected by the radio access network) and transfer to a new radio access connection with network access node 110. Such mobility procedures, including radio measurements, cell selection/reselection, and handover are established in the various network protocols and may be employed by terminal devices and the radio access network in order to maintain strong radio access connections between each terminal device and the radio access network across any number of different radio access network scenarios.

FIG. 4 shows an exemplary internal configuration of a network access node, such as network access node 110, according to some aspects. As shown in FIG. 4, network access node 110 may include antenna system 402, radio transceiver 404, and baseband subsystem 406 (including physical layer processor 408 and protocol controller 410). In an abridged overview of the operation of network access node 110, network access node 110 may transmit and receive wireless signals via antenna system 402, which may be an antenna array including multiple antennas. Radio transceiver 404 may perform transmit and receive RF processing to convert outgoing baseband samples from baseband subsystem 406 into analog radio signals to provide to antenna system 402 for radio transmission and to convert incoming analog radio signals received from antenna system 402 into baseband samples to provide to baseband subsystem 406. Physical layer processor 408 may be configured to perform transmit and receive PHY processing on baseband samples received from radio transceiver 404 to provide to controller 410 and on baseband samples received from controller 410 to provide to radio transceiver 404. Controller 410 may control the communication functionality of network access node 110 according to the corresponding radio communication technology protocols, which may include exercising control over antenna system 402, radio transceiver 404, and physical layer processor 408. Each of radio transceiver 404, physical layer processor 408, and controller 410 may be structurally realized with hardware (e.g., with one or more digitally-configured hardware circuits or FPGAs), as software (e.g., as one or more processors executing program code defining arithmetic, control, and I/O instructions stored in a non-transitory computer-readable storage medium), or as a mixed combination of hardware and software. In some aspects, radio transceiver 404 may be a radio transceiver including digital and analog radio frequency processing and amplification circuitry. In some aspects, radio transceiver 404 may be a software-defined radio (SDR) component implemented as a processor configured to execute software-defined instructions that specify radio frequency processing routines. In some aspects, physical layer processor 408 may include a processor and one or more hardware accelerators, wherein the processor is configured to control physical layer processing and offload certain processing tasks to the one or more hardware accelerators. In some aspects, controller 410 may be a controller configured to execute software-defined instructions that specify upper-layer control functions. In some aspects, controller 310 may be limited to radio communication protocol stack layer functions, while in other aspects controller 410 may also be configured for transport, internet, and application layer functions.

Network access node 110 may thus provide the functionality of network access nodes in radio communication networks by providing a radio access network to enable served terminal devices to access communication data. For example, network access node 110 may also interface with a core network, one or more other network access nodes, or various other data networks and servers via a wired or wireless backhaul interface.

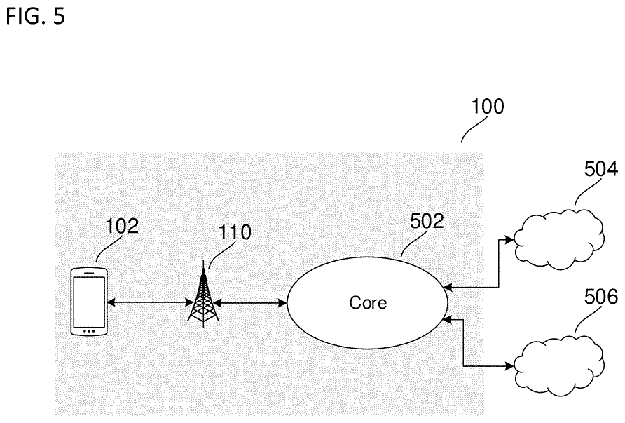

As previously indicated, network access nodes 110 and 120 may interface with a core network. FIG. 5 shows an exemplary configuration in accordance with some aspects where network access node 110 interfaces with core network 502, which may be, for example, a cellular core network. Core network 502 may provide a variety of functions to manage operation of radio communication network 100, such as data routing, authenticating and managing users/subscribers, interfacing with external networks, and various other network control tasks. Core network 502 may therefore provide an infrastructure to route data between terminal device 104 and various external networks such as network 504 and network 506. Terminal device 102 may thus rely on the radio access network provided by network access node 110 to wirelessly transmit and receive data with network access node 110, which may then provide the data to core network 502 for further routing to external locations such as data networks 504 and 506 (which may be packet data networks (PDNs)). Terminal device 102 may therefore establish a data connection with data network 504 and/or data network 506 that relies on network access node 110 and core network 502 for data transfer and routing.

Link adaptation methods using machine learning methods, such as K-NN and SVM, have begun to be implemented in areas of wireless technology (e.g. Wifi). These methods have shown significant performance gains by using spectrum efficiency calculations based on link level simulation. However, these methods have several drawbacks.

One drawback is that these methods are focused on the Wifi system, which is obviously quite different from cellular systems such as LTE based technologies or even next generation (NG) radio technologies. The K-NN and SVM methods have a very high computational complexity, and are therefore not suitable in situations with stricter latency requirements, e.g. LTE baseband processing requirements.

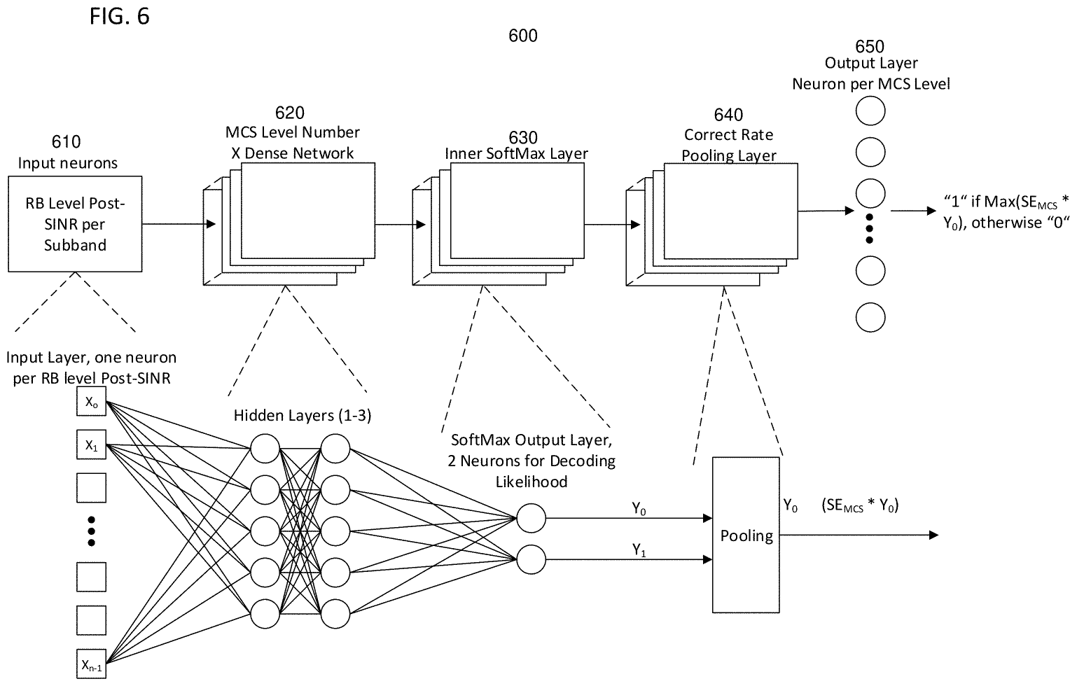

FIG. 6 shows a deep neural network (DNN) scheme 600 according to some aspects. It is appreciated that DNN scheme 600 is exemplary in nature and may therefore may be simplified for purposes of this explanation.

DNN scheme 600 includes multiple dense networks, each corresponding to one enabled Modulation and Coding Scheme (MCS) level (i.e. MCS index), which is shown starting at the second level of the scheme (“MCS Level Number×Dense Network” and going forward). The input layer 610 of the scheme 600 consist of one neuron per resource block (RB) level post-signal-to-interference-noise-ratio (post-SINR) per sub-band, i.e. one neuron per RB level post-SINR. A resource block (RB) is the smallest unit of resources in the time and frequency domain that can be allocated to a user. Accordingly, each post-SINR RB input may be determined from a RB from the Physical Downlink Shared Channel (PDSCH), which typically occupies a majority of the time and frequency resources in an LTE system. The scheme may include in the range of 1-3 hidden layers per MCS Level Number 620, and an Inner Softmax layer 630 per MCS level, each Inner Softmax layer consisting of two neurons for providing a decoding likelihood. The scheme 600 further consist of a Correct Rate Pooling Layer 640 per MCS level, and finally, an Output Layer 650 with one neuron per MCS level.

However, scheme 600 may present several drawbacks. For example, scheme 600 provides for a complex DNN structure in which each MCS level requires a dense network. This may potentially bring up redundant DNN parameters, resulting in poor applicability in situations where more MCS levels are enable by the communication device, since each MCS level will need its own dense network.

In some aspects of this disclosure, methods and devices to support LTE Physical Downlink Shared Channel (PDSCH) link adaptation based on LTE Channel Quality Indicator (CQI) feedback is provided. The feedback may be provided in the uplink from terminal device 102 to network access node 110, for example, and may include MCS information, e.g. a preferred MCS index.

The methods and devices herein provide for low computational complexity and low latency within the baseband processing. By using post-SINR and MCS as inputs to a DNN scheme, only one DNN dense network may be required for all MCS levels as opposed to one DNN dense network for each MSC level. As a result, a simplified and optimized structure ensuring extendibility, fewer parameters resulting in reduced storage and computation consumption/cost, and more accurate results is achieved.

The post-equalization SINR is computed as a function of the equalizer used in data demodulation of the baseband modem 206. For example, in the case that a maximum ratio combining equalizer is used, the post-equalization SINR may be obtained by determining a squared Frobenius norm of the channel matrix. In another example, in the case that a MIMO minimum mean square error equalizer is used, the post-equalization SINR may be obtained by computing the channel covariance matric and deriving the SINR for each code word. In another example, in the case that a MIMO maximum likelihood detection equalizer is used, the post-equalization SINR may be derived from the eigenvalues for the modified channel covariance matrix.

Prior to the post-equalization SINR being fed to the DNN link adaptation process, the baseband modem 206 may remove guard intervals of the received OFDM signal and process it via FFT to convert the received time domain symbols into the frequency domain. The channel estimation and the noise level estimation are typically performed based on the reference symbols in the frequency domain and may be further subject to normalization prior to feedback estimation. The feedback estimation, including the determination of the CSI parameters (e.g. RI, PMI, wbCQI, sbCQI), is performed based on the channel estimation and/or noise level estimation, e.g. the post-equalization SINR.

DNN link adaptation implements the CSI estimation (i.e. MCS levels) for feedback used for reporting the CSI from terminal device 102 to network access node 110 with a number of hardware and/or software blocks, including de-precoding and post-equalization SINR components prior to providing the post-equalization SINR to the DNN link adaptation models described herein.

The de-precoding block may be configured to receive a normalized channel estimation matrix, obtained from a channel estimation output normalized with a noise level estimation output. The frequency selective noise covariance matrix is estimated on a PRB basis, and the resulting normalized channel matrix is fed to the de-precoding block, where the normalized channel estimate matrix may be multiplied by all available precoding matrices to produce a channel equivalent matrix.

This is followed by the post-equalization SINR calculation, which is performed according to the equalizer in use in the baseband modem 206 (e.g. a maximum ratio combining equalizer, a MIMO minimum mean square error equalizer, a MIMO maximum likelihood detection equalizer, etc.).

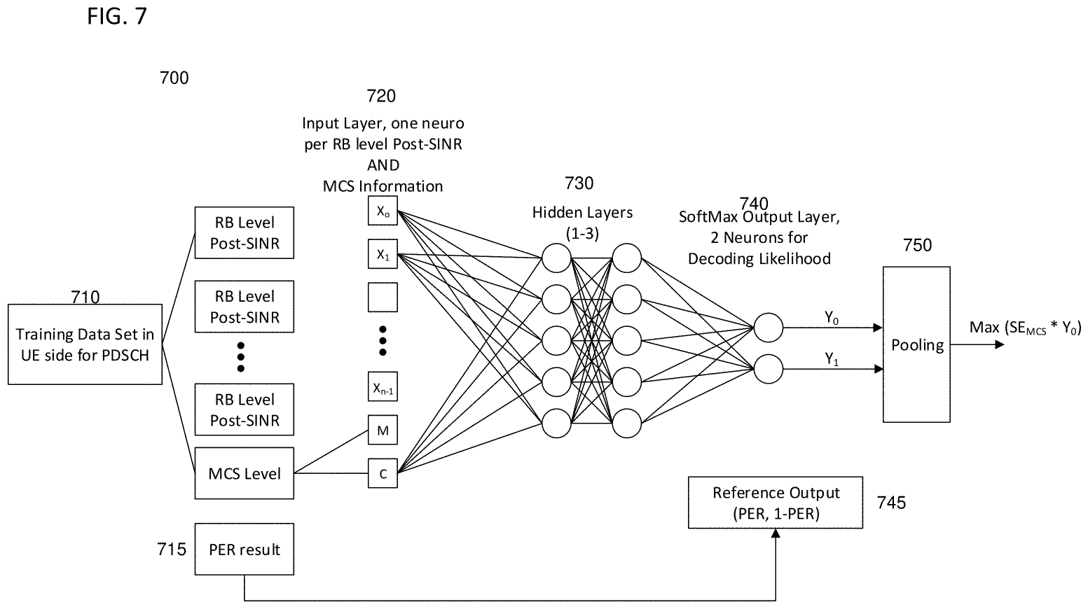

FIG. 7 shows a DNN scheme 700 for PDSCH link adaptation according to some aspects. It is appreciated that DNN scheme 700 is exemplary in nature and may therefore may be simplified for purposes of this explanation.

Scheme 700 divides the DNN structure into several layers with a core-part being a well-trained, fully-connected dense network (with about 1-3 hidden layers). The input layer 720 contains not only RB level post-SINR information (blocks but also contains MSC information (blocks M and C). Therefore, the number of neurons in the input layer is equal to the RB number of the sub-band plus two. In addition to most of the neurons having an input corresponding to a RB level post-SINR, there are two additional neurons with one neuron representing a modulation order and another neuron representing a coding rate. The Hidden Layer 730 includes a fully-connected dense network that is trained by post-SINR, MCS, and PER results. The training process of the dense network will be covered later in this disclosure.

The Inner Softmax layer 740 processes the output from the Hidden Layers 730 and transforms the output into two parameters, Y₀ and Y₁. These two values denote the decoding likelihood, where Y₀ is the correct rate and Y₁ is the error rate. Therefore, Y₀+Y₁=1, and Y₀,Y₁≥0.

The Pooling Layer 750 may use every enabled MCS level as an input, where each MCS level generates a Y₀ value. A correct rate pooling layer is used to set a threshold and pass Y₀ to the next output layer, keeping Y₀ when it is larger than the threshold, otherwise setting Y₀ to 0. The output layer of Pooling Layer 750 is designed to transform all Y₀ values to one hot encoded vector, where each neuron in the output layer corresponds to an MCS level, and produces “1” if Max(SE_{MCS}×Y₀), otherwise, it produces “0”. The SE_{MCS} is the spectrum efficiency of the MCS and the Max(⋅) function returns true when SE_{MCS}×Y₀ is at a maximum over all MCS levels. If all Y₀ values are set to 0 in the correct pooling layer, the neuron corresponding to the lowest MCS level will output “1.” The MCS represented by the output vector is selected as the feedback MCS for link adaptation. This CQI feedback is provided by the terminal device in the uplink to the network access node, e.g. uplink communication between terminal device 102 and network access node 110.

Table 1 illustrates exemplary detailed DNN architecture design considerations. The Parameters column is the model component considered, whereas the Solution column provides the implementation.

TABLE 1

| Parameters | Solution |
|---|---|
| Network Model | Multilayer Perceptron |
| Neuron Type | ReLU (Rectified Linear Unit) |
| Cost Function | Softmax & Cost-entropy |
| Optimizer | Adam Optimizer |
| Classification | One-hot encoding |

A Multilayer Perceptron (MLP) is a typical class of feedforward artificial neural network. An MLP consists of three or more layers: an input layer, an output layer, and one or more hidden layers. Each node in the output and hidden layers is a neuron that implements a nonlinear activation function. MLP utilizes back-propagation for training, which is a supervised learning technique. A MLP consists of three or more layers of nonlinearly activating nodes and are fully connected with each node in one layer connecting with a certain weight to every node in the following layer. The learning occurs in the MLP by modifying the weights after each piece of data is processed, based on the degree of error in the output compared to the expected result. If the error in output node j in the nth data point is represented by eⱼ(n)=dⱼ(n)−yⱼ(n), where d is the target value and y is the produced value, the node weight are adjusted based on corrections that minimize error in the entire output, given by ε(n)=½Σⱼeⱼ²(n). Applying gradient decent, the change in each weight is therefore:

$$Δ {w}_{j i} ( n ) = - η \frac{\partial ɛ ( n )}{\partial {v}_{j} ( n )} {y}_{i} ( n ) ,$$

where yᵢ is the output of the previous neuron, η is the learning rate, which is selected for quick convergence, and vⱼ(n) is the induced local field.

ReLU (Rectified Linear Unit) is used as the neuron type to realize a nonlinear activation function in some aspects of this disclosure, which is defined as f(x)=max(0, x), where x is the input to a neuron. Compared with the other neuron types, ReLU provides many advantages such as efficient gradient propagation and efficient computation, among other advantages.

Softmax is used to represent a categorical distribution. The predicted probability for the j-th class given a input vector z is

$${p}_{j} = \frac{{e}^{{z}_{j}}}{{\sum }_{k} {e}^{{z}_{k}}} .$$

The output of the softmax function may be used to represent a categorical distribution, i.e. a probability distribution over K different outcomes. To evaluate the predicted results, we use the cross-entropy to calculate the loss. The cross-entropy between two probability distributions, p and q, over the same underlying set of events measures the average number of bits needed to identify an event drawn from the set, if a coding scheme is used that is optimized for an “unnatural” probability distribution q, rather than the “true” distribution p.

Adam Optimizer, short for Adaptive Moment Estimation Optimizer, is used to calculate and update the gradients during DNN training. It can be used to update network weights iterative based in training data. It is an optimization algorithm that employs an adaptive gradient algorithm that maintains a per-parameter learning rate which may improve performance in conditions with sparse gradients, and also employs a root mean square propagation that maintains a per-parameter learning rate which is adapted based on the average recent magnitudes of the gradients for the weight.

One-hot encoding is a coding method that encodes the classification value equals to a vector among which only correct classification index value equals to 1 and all the others are 0.

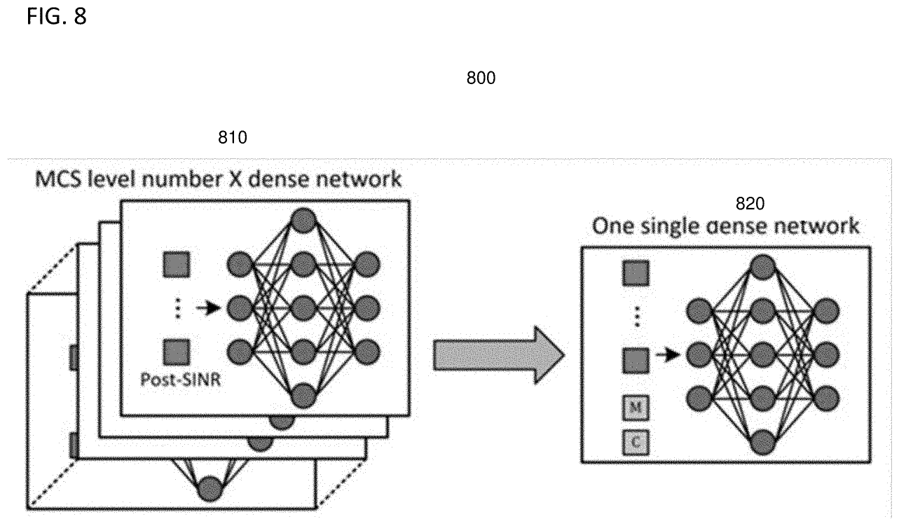

FIG. 8 shows a diagram 800 illustrating the simplification of the DNN structure according to some aspects of this disclosure. Different from previous methods, the MCS information (e.g. M—modulation order; C— coding rate; also may include spatial streams, types of modulation and coding, data rates, bandwidths, or the like) is directly used as neuron inputs in one, single dense network 850. In this manner, the number of dense networks is reduced, i.e. there is no need for one dense network for each and every MCS level. Accordingly, the algorithm structure is greatly predigested since all that is needed is one network rather than, for example, fourteen networks (a typical amount of enabled MCS levels). Furthermore, there is no need to increase the number of hidden layers and neurons in each layer. As a result, the amount of DNN parameters (i.e. weights and biases) are greatly reduced, thereby saving storage space which is meaningful since link adaptation is conducted at the terminal device (i.e. UE) side.

Table 2 below shows the relationship between exemplary MCS Index levels and two MSC parameters, modulation order (M) and coding rate (C), used at the input neuron level in some aspects.

TABLE 2

| MCS Index | Modulation Order | Coding Rate |
|---|---|---|
| (I_{MCS}) | (M) | (C) |
| 0 | 2 | 120 |
| 2 | 2 | 193 |
| 4 | 2 | 308 |
| 6 | 2 | 449 |
| 8 | 2 | 602 |
| 10 | 4 | 378 |
| 12 | 4 | 490 |
| 14 | 4 | 616 |
| 17 | 6 | 466 |
| 19 | 6 | 567 |
| 21 | 6 | 666 |
| 23 | 6 | 772 |
| 24 | 6 | 873 |
| 25 | 6 | 948 |

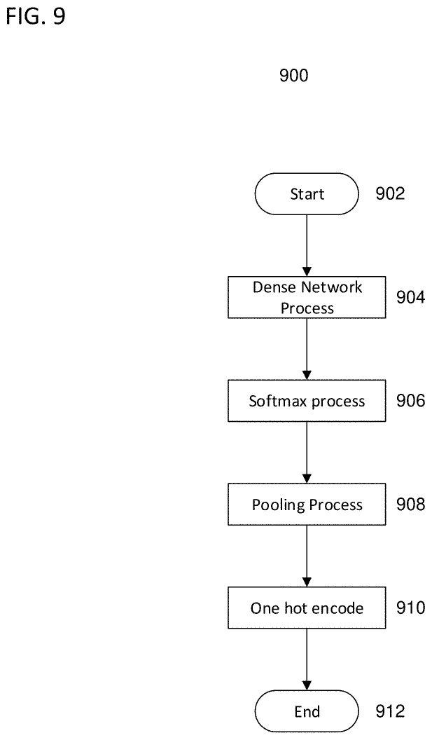

In LTE PDSCH link adaptation, Mutual Information Effective SINR Mapping (MIESM) is a widely-used method to decide feedback CQI values by calculating the RB's post-SINR. MIESM maps the instantaneous RB SINRs into a single instantaneous, effective SINR_{eff}. In some aspects of this disclosure, the DNN method is implemented instead of MIESM. The detailed DNN link adaption process is shown in FIG. 9.

FIG. 9 shows a flowchart 900 illustrating a DNN link adaptation process in some aspects. It is appreciated that flowchart 900 is exemplary in nature and may therefore be simplified for purposes of this explanation.

In 902, the DNN link adaptation process starts after the time signal has been received. The process/algorithm shown in flowchart 900 is implemented in each sub-band of DL-SCH.

In the Dense Network process 904, the RB level post-SINRs and different MCS parameters are passed to the dense network. Matrix operations with weights W, biases b, and input x are performed as follows:

$$\begin{matrix}{y}_{h 1} = R e L U ( x {W}_{h 1} + {b}_{h 1} ) \\ … \\ {y}_{h ( i + 1 )} = R e L U ( {y}_{h i} {W}_{h ( i + 1 )} + {b}_{h ( i + 1 )} ) \\ … \\ y = {y}_{h n} {W}_{o u t} + {b}_{o u t}\end{matrix}$$

The x represents RB level post-SINRs and MCS information, x=[SINR, M, C], where M is the modulation order and C is the coding rate. Subscripts are used to distinguish parameters between different layers.

In the Softmax process 906, the output(y) from the dense network process 904 is transformed into decoding likelihood Y₀ and Y₁ by a softmax function:

$$( \begin{matrix}{Y}_{0} \\ {Y}_{1}\end{matrix} ) = Softmax ( y )$$

In the Pooling Process 908, the value of Y₀ is corrected according to the following formula:

$${Y}_{0} = \{ \begin{matrix}0 , & {Y}_{0} < threshold \\ {Y}_{0} , & {Y}_{0} \geq threshold\end{matrix}$$

Where the threshold is a predetermined value which may be based off a packet error rate (PER) defined by a standard, e.g. 0.1 for a PER of 10%.

In the One hot encode 910, all Y₀ (i.e. one Y₀ from each of the input MCS parameters) are encoded to one hot vector, v=[v₀, v₁, . . . , vₙ].

$$v = \{ \begin{matrix}1 , & Max ( S {E}_{M C S} \times {Y}_{0} ) \\ 0 , & otherwise\end{matrix}$$

At the End 912, the algorithm selects the MCS which v_{MCS}=1 as the feedback MCS and sends it to the network access node, e.g. eNodeB.

Prior to implementing the method shown by flowchart 900, the terminal device may process a received signal in an OFDM communication scheme according to known signal processing methods in order to obtain the post-equalization SINR. For example, this may include receiving the OFDM signal with an antenna and performing front-end processing of the received OFM signal, and furthermore, removing the guard intervals, FFT processing, noise level estimation, channel estimation, and normalization of the received data symbols prior to implementing the feedback estimation CSI computation methods described herein. Accordingly, it is appreciated that baseband modem 206 is also fitted with hardware and/or software to perform these functions.

The DNN methods and devices of this disclosure were tested in an LTE link level simulator (LTE LLS). Three hidden layers were used, and the number of neurons in each layer were 16, 32, and 16. It is appreciated that neuron numbers may be used within the scope of this disclosure. The number of DNN parameters of the DNN architecture in disclosure were compared with other methods implementing dense networks for MCS link adaptation.

1250 parameters were needed to train and save for implementing the DNN link adaptation methods and algorithms described herein, including 1184 weights and 66 biases. As a comparison, 17052 parameters were needed to implement other known DNN link adaptation methods which use one dense network for each MCS level. Each of the 14 dense networks required 1218 parameters (1152 weights and 66 biases). In sum, by implementing the DNN link adaption methods and algorithms described herein, a significant reduction in parameter cost (about 92.6%) is achieved.

Next, a performance analysis comparing the DNN link adaptation methods of this disclosure against conventional MIESM methods was conducted. A dataset consisting of 5611200 training samples and about 1120000 test samples was used. The SNR range for transmission in the eNB was [−10 dB, 40 dB].

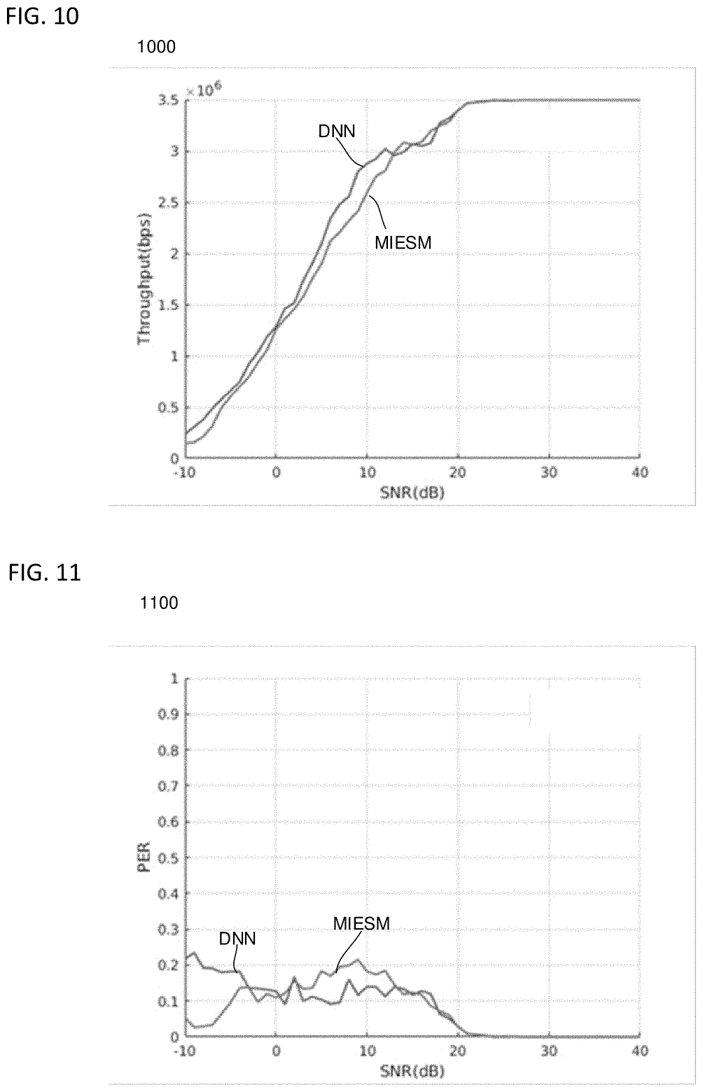

FIG. 10 shows a graph 1000 plotting the throughput (in bps) vs the Signal-to-Noise Ratio (SNR, in dBs) comparing the results of the DNN implementation of this disclosure with conventional MIESM methods. As can be seen in graph 1000, the DNN method of this disclosure provided better performance than MIESM at most SNR values, especially at lower SNR values.

FIG. 11 shows a graph 1100 plotting the Packet Error Rate (PER) vs. the SNR comparing the results of the DNN implementation of this disclosure with conventional MIESM methods. The DNN implementation achieved similar performance to MIESM, with notable improvements in performance in the 0 to 15 dB SNR range.

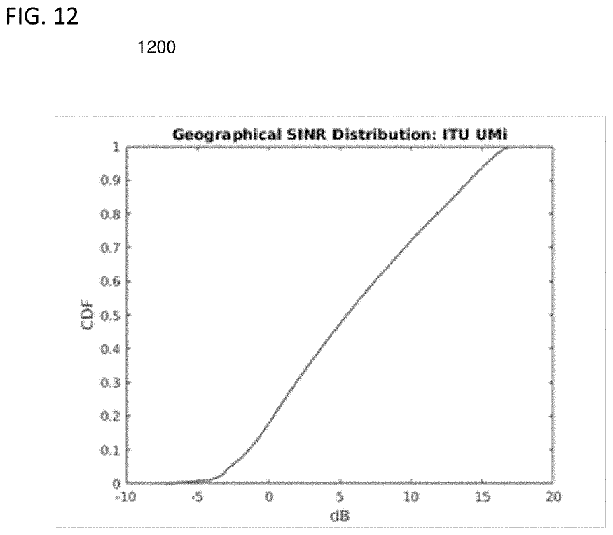

The gain throughput between the DNN methods of this disclosure and conventional MIESM methods as calculated with a typical SNR distribution in an International Telecommunication Union (ITU) Urban Micro (UMi) scenario as defined in 3GPP TS 36.814. The cumulative distribution function (CDF) curve of SINR distribution is shown in FIG. 12.

The CDF data was applied into the throughput data of FIG. 10 using interpolation, and the overall gain of DNN with respect to MIESM in ITU UMi was computed to be about 6.58%.

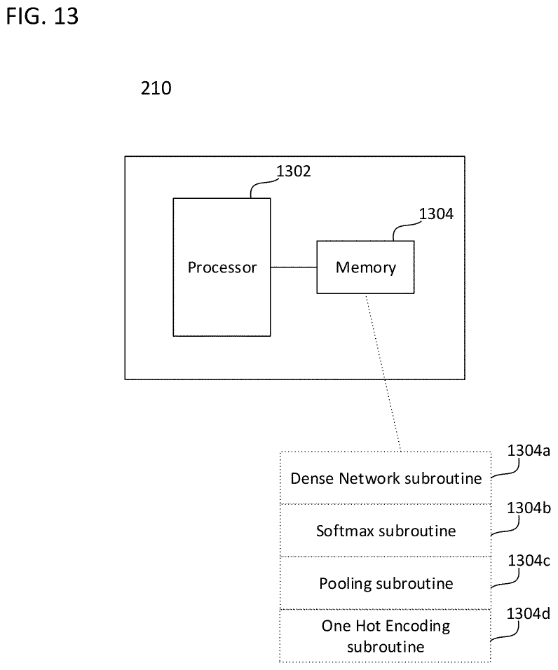

FIG. 13 shows an exemplary internal configuration of controller 210 according to some aspects. As shown in FIG. 13, controller 210 may include processor 1302 and memory 1304. Processor 1302 may be a single processor or multiple processors, and may be configured to retrieve and execute program code to perform the transmission and reception, channel resource allocation, and cluster management as described herein. Processor 1302 may transmit and receive data over a software-level connection that is physically transmitted as wireless radio signals by digital signal processor 208, RF transceiver 204, and antenna 202. Memory 1304 may be a non-transitory computer readable medium storing instructions for one or more of a Dense Network subroutine 1304a, a Softmax subroutine 1304b, a Pooling subroutine 1304c, and/or one hot encoding subroutine 1304d.

Dense Network subroutine 1304a, Softmax subroutine 1304b, Pooling subroutine 1304c, and/or one hot encoding subroutine 1304d may each be an instruction set including executable instructions that, when retrieved and executed by processor 1302, perform the functionality of controller 210 as described herein. In particular, processor 1302 may execute Dense Network subroutine 1304a for one of more sub-bands of DL-SCH after a time signal has been received. As previously described, Dense Network subroutine 1304a may therefore include executable instructions for implementing a dense network using a plurality of post-SINR RBs and MCS information (coding rate and/or modulation order) as inputs. This may further include performing matrix operations on these inputs with weights and biases.

Processor 1302 may execute Softmax subroutine 1304b for transforming the dense network's output into decoding likelihood Y₀ and Y₁. Softmax subroutine 1304b may therefore include executable instructions to apply a Softmax function. Processor 1302 may execute pooling subroutine 1304c in order correct the value of each corresponding Y₀ (i.e. correct rate). Pooling subroutine 1304c may therefore contain executable instructions to compare Y₀ to a threshold value, and retain Y₀ if it is equal to or greater than the threshold value, else, set it to “0.”

Processor 1302 may execute One Hot Encoding subroutine 1304d for encoding all values of Y₀ to one hot vector, i.e. each value of Y₀ corresponding to an MCS input parameter. One Hot Encoding subroutine 1304d may therefore include executable instructions to determine a maximum Y₀ value and setting it equal to “1,” and setting all other Y₀ values to “0.” Processor 1302 may then be configured to select the MCS index corresponding to the value of “1,” and provide this information in a feedback to the network.

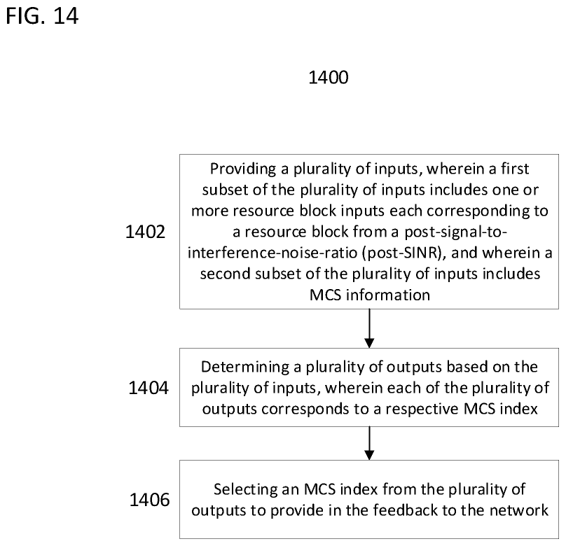

FIG. 14 shows a flowchart 1400 for a device to determine an MCS index to provide in a feedback according to some aspects. It is appreciated that flowchart 1400 is exemplary in nature and may therefore be simplified for purposes of this explanation.

In 1402, a plurality of inputs, wherein a first subset of the plurality of inputs includes one or more resource block inputs each corresponding to a resource block from a post-signal-to-interference-noise-ratio (post-SINR), and wherein a second subset of the plurality of inputs includes MCS information, is provided.

In 1404, the device determines a plurality of outputs based on the plurality of inputs, wherein each of the plurality of outputs corresponds to a respective MCS index.

In 1406, the device selects an MCS index from the plurality of outputs to provide in the feedback to the network.

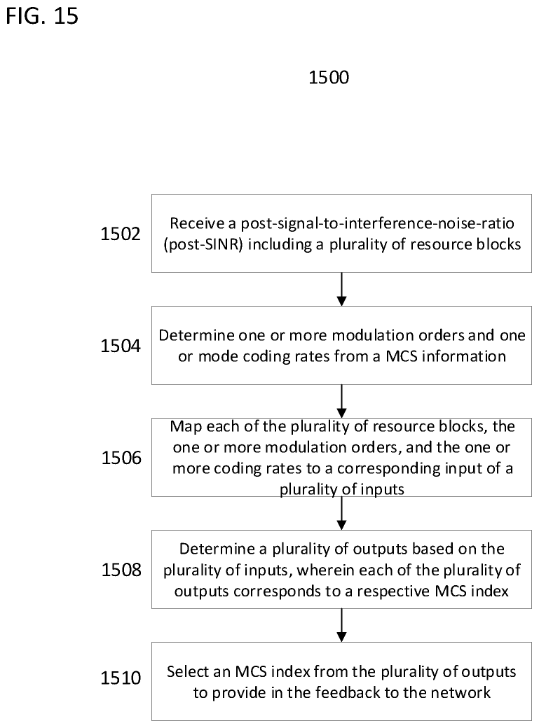

FIG. 15 shows a flowchart 1500 a device to determine an MCS index to provide in a feedback according to some aspects. It is appreciated that flowchart 1500 is exemplary in nature and may therefore be simplified for purposes of this explanation.

In 1502, the device receives a post-signal-to-interference-noise-ratio (post-SINR) including a plurality of resource blocks. In 1504, the device determines one or more modulation orders and one or mode coding rates from a MCS information. In 1506, the device maps each of the plurality of resource blocks, the one or more modulation orders, and the one or more coding rates to a corresponding input of a plurality of inputs. In 1508, the device determines a plurality of outputs based on the plurality of inputs, wherein each of the plurality of outputs corresponds to a respective MCS index. In 1510, the device selects an MCS index from the plurality of outputs to provide in the feedback to the network.

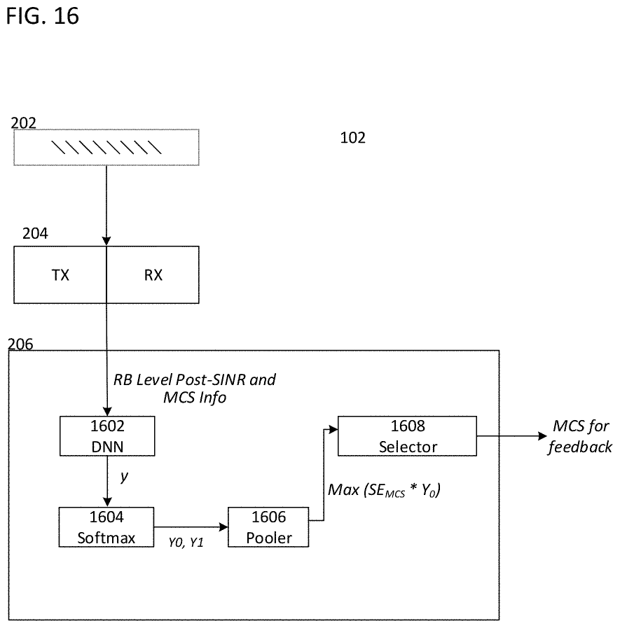

FIG. 16 shows an internal diagram a terminal device 102 depicting components according to some aspects. Accordingly, the illustrated depiction of FIG. 16 may omit certain components of terminal device 102 that are not directly related to the DNN link adaptation schemes described herein. Additionally, components depicted as being separate in FIG. 16 may be incorporated into a single, hybrid component that performs the same functions as the separate components, and, similarly, single components may be split into two or more separate components that perform the same function as the single component.

As shown in FIG. 16, the baseband modem 206 may include link adaptation circuitry such as DNN circuitry 1602 for receiving as inputs the RB level post-SINR and MCS information (modulation order and coding rate) and performing the dense network process described herein via one or more hidden layers. DNN circuitry 1602 may include a circuit configured to perform the tasks of a one or more neurons of the DNN, e.g. apply weights and/or biases to each input of the neuron and provide a neuron output. Baseband modem 206 may further include decoding likelihood 1604 circuitry for determining a decoding likelihood (correct: Y₀ and error: Y₁) from the output of DNN circuitry 1602 for each of one or more MCS levels (i.e. MCS indexes). Decoding likelihood 1604 circuitry may be configured to apply a softmax function as described herein. Baseband modem 206 may further include Pooling circuitry or Pooler 1606 for using every enabled MCS level as an input, wherein a generated Y₀ is attributed to each MCS level. A correct rate pooling layer is used to set a threshold and pass Y₀ to the next output layer, keeping Y₀ when it is larger than the threshold, otherwise setting Y₀ to 0. Baseband modem may further include Selector circuitry 1608 configured to encode all Y₀ (i.e. one Y₀ from each of the input MCS parameters) to one hot vector, select the maximum decoding likelihood value in the vector, and select the MCS index corresponding to the maximum decoding likelihood value to provide in the feedback to the network. Selector 1608 may accomplish this by, after encoding all Y₀ into a vector, setting the maximum value to 1 and all other values to 0. Thereafter, selector 1608 may be configured to select the MCS index corresponding the vector position, v_{mcs}, equal to 1, i.e. the MCS index corresponding to the decoding likelihood in the vector which has been set to 1.

While the above descriptions and connected figures may depict device components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc. Also, it is appreciated that particular implementations of hardware and/or software components are merely illustrative, and other combinations of hardware and/or software that perform the methods described herein are within the scope of the disclosure.

It is appreciated that implementations of methods detailed herein are exemplary in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

The following examples pertain to further aspects of this disclosure, wherein the subject matter recited in each Example may be combinable with subject matter recited in any other Example or other parts of the disclosure herein:

In Example 1, a method for a communication device to determine a Modulation and Coding Scheme (MCS) index to provide in a feedback to a network, the method including: providing a plurality of inputs, wherein a first subset of the plurality of inputs includes one or more resource block inputs each including a post-signal-to-interference-noise-ratio (post-SINR), and wherein a second subset of the plurality of inputs includes MCS information; determining a plurality of decoding likelihoods based on the plurality of inputs, wherein each of the plurality of decoding likelihoods corresponds to a respective MCS index; and selecting an MCS index based on the plurality of decoding likelihoods to provide in the feedback to the network.

In Example 2, the subject matter of Example(s) 1 may include wherein a first input of the second subset corresponds to a modulation order.

In Example 3, the subject matter of Example(s) 1-2 may include wherein a second input of the second subset corresponds to a coding rate.

In Example 4, the subject matter of Example(s) 1-3 may include wherein the plurality of inputs are fed to an input layer of a deep neural network (DNN).

In Example 5, the subject matter of Example(s) 4 may include wherein the determining of a plurality of outputs based on the plurality of inputs is determined by one or more hidden layers of the DNN.

In Example 6, the subject matter of Example(s) 5 may include wherein there are 1 to 3 hidden layers.

In Example 7, the subject matter of Example(s) 5-6 may include wherein each hidden layer includes up to about 32 neurons.

In Example 8, the subject matter of Example(s) 1-7 may include applying weights and biases to the plurality of inputs at each of the neurons to obtain a plurality of outputs.

In Example 9, the subject matter of Example(s) 8 may include transforming each of the plurality of outputs into a respective decoding likelihood including a first rate value.

In Example 10, the subject matter of Example(s) 9 may include wherein the transforming includes applying a softmax function to determine the first rate value and a second rate value for each of the intermediate outputs.

In Example 11, the subject matter of Example(s) 9-10 may include wherein the first rate value includes a correct rate.

In Example 12, the subject matter of Example(s) 10-11 may include wherein the second rate value includes an error rate.

In Example 13, the subject matter of Example(s) 12 may include wherein a sum of the first rate value and the second rate value is 1.

In Example 14, the subject matter of Example(s) 9-13 may include wherein determining the plurality of outputs includes correcting the first rate value based on a threshold value.

In Example 15, the subject matter of Example(s) 14 may include wherein when the first rate value is greater or equal to the threshold value, the first rate value remains unchanged.

In Example 16, the subject matter of Example(s) 14 may include wherein when the first rate value is less than the threshold value, the first rate value is set to zero.

In Example 17, the subject matter of Example(s) 14-16 may include encoding the first rate value for each of the intermediate outputs to a vector, wherein the vector includes the plurality of outputs.

In Example 18, the subject matter of Example(s) 1-17 may include determining a maximum value from the plurality of outputs.

In Example 19, the subject matter of Example(s) 18 may include wherein determining the maximum value from the plurality of vectors includes setting the maximum value to a non-zero value, and setting non-maximum values from the plurality of outputs to zero.

In Example 20, the subject matter of Example(s) 1-19 may include transmitting the feedback to a network access node in the network.

In Example 21, the subject matter of Example(s) 1-20 may include wherein the resource blocks inputs are determined from a signal received at the communication device from the network. The signal received may include PDSCH data.

In Example 22, a communication device configured to determine a Modulation and Coding Scheme (MCS) index to provide in a feedback to a network, with one or more processors configured to receive a post-signal-to-interference-noise-ratio (post-SINR) for each of a plurality of resource blocks; determine one or more modulation orders and one or mode coding rates; map the post-SINR for each of the plurality of resource blocks, the one or more modulation orders, and the one or more coding rates to a plurality of inputs; determine a plurality of outputs based on the plurality of inputs, wherein each of the plurality of outputs corresponds to a respective MCS index; and select an MCS index based on the plurality of outputs to provide in the feedback to the network. The communication device may be further configured to perform the subject matter recited according to Examples 2-21.

In Example 23, a communication device including a deep neural network (DNN) determiner configured to receive a first subset of inputs including a plurality of post-signal-to-interference-noise-ratio (post-SINR) resource blocks (RBs) and a second subset of inputs including modulation and coding scheme (MCS) information, and provide a DNN output based on the first subset of inputs and the second subset of inputs; a decoding likelihood determiner configured to receive the DNN output and provide a plurality of decoding likelihoods, each decoding likelihood corresponding to an MCS index; a pooler configured to set a decoding likelihood threshold and compare each of the plurality of decoding likelihoods to the decoding likelihood threshold; and a selector configured to select a maximum decoding likelihood of the plurality of decoding likelihoods.

In Example 24, the subject matter of Example(s) 23 may include wherein the selector is further configured to select the MCS index corresponding to the maximum decoding likelihood.

In Example 25, the subject matter of Example(s) 24 may include wherein the communication device includes a transmitter to transmit the selected MCS index.

In Example 26, the subject matter of Example(s) 23-25 may include wherein the MCS information includes a modulation order.

In Example 27, the subject matter of Example(s) 23-26 may include wherein the MCS information includes a coding rate.

In Example 28, the subject matter of Example(s) 23-27 may include wherein the DNN determiner includes a DNN including one or more hidden layers.

In Example 29, the subject matter of Example(s) 28 may include wherein the DNN includes 1-3 hidden layers.

In Example 30, the subject matter of Example(s) 28-29 may include wherein each hidden layer includes a plurality of neurons.

In Example 31, the subject matter of Example(s) 28-30 may include wherein each hidden layer includes up to about 32 neurons.

In Example 32, the subject matter of Example(s) 30-31 may include wherein each neuron is configured to apply a weight and/or bias to a respective neuron input and provide a respective neuron output.

In Example 33, the subject matter of Example(s) 23-32 may include wherein the decoding likelihood determiner is configured to transform the DNN output by applying a softmax function in order to determine the plurality of decoding likelihoods.

In Example 34, the subject matter of Example(s) 23-33 may include wherein when a respective decoding likelihood of the plurality of decoding likelihoods is less than the decoding likelihood threshold, the respective decoding likelihood is set to zero.

In Example 35, the subject matter of Example(s) 23-33 may include wherein when a respective decoding likelihood of the plurality of decoding likelihoods is greater than or equal to the decoding likelihood threshold, the respective decoding likelihood is unchanged.

In Example 36, the subject matter of Example(s) 23-35 may include wherein the selector is configured to encode the plurality of decoding likelihoods to a vector.

In Example 37, the subject matter of Example(s) 36 may include wherein the maximum decoding likelihood in the vector is set to a non-zero value.

In Example 38, the subject matter of Example(s) 36-37 may include wherein non-maximum decoding likelihoods in the vector are set to zero.

In Example 39, the subject matter of Example(s) 23-38 may include wherein the post-SINR for each of the plurality of resource blocks is determined from a signal received by a receiver of the communication device. The signal received may include PDSCH data.

In Example 40, a communication device including means for receiving a post-signal-to-interference-noise-ratio (post-SINR) for each of a plurality of resource blocks; means for determining one or more modulation orders and one or mode coding rates; means for mapping the post-SINR for each of the plurality of resource blocks, the one or more modulation orders, and the one or more coding rates to a plurality of inputs; means for determining a plurality of outputs based on the plurality of inputs, wherein each of the plurality of outputs corresponds to a respective MCS index; and means for selecting an MCS index from the plurality of outputs to provide in the feedback to the network.

In Example 41, one or more non-transitory computer-readable media storing instructions thereon that, when executed by at least one processor, direct the at least one processor to perform a method or realize a device as described in any preceding example.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

1. A communication device comprising one or more processors configured to:
receive a first subset of inputs comprising a plurality of post-signal-to-interference-noise-ratio (post-SINR) resource blocks (RBs) and a second subset of inputs comprising modulation and coding scheme (MCS) information, and provide a deep neural network (DNN) output based on the first subset of inputs and the second subset of inputs;
provide a plurality of decoding likelihoods based on the DNN output, each decoding likelihood corresponding to an MCS index;
set a decoding likelihood threshold and compare each of the plurality of decoding likelihoods to the decoding likelihood threshold; and
determine a maximum decoding likelihood of the plurality of decoding likelihoods.

2. The communication device of claim 1, wherein the one or more processors are further configured to select an MCS index corresponding to the maximum decoding likelihood.

3. The communication device of claim 1, wherein the communication device comprises a transmitter to transmit the selected MCS index.

4. The communication device of claim 1, wherein the MCS information comprises a modulation order.

5. The communication device of claim 1, wherein the MCS information comprises a coding rate.

6. The communication device of claim 1, wherein the one or more processors are configured to implement a DNN comprising one or more hidden layers.

7. The communication device of claim 6, wherein each hidden layer comprises up to about 32 neurons.

8. The communication device of claim 7, wherein each neuron is configured to apply a weight and/or bias to a respective neuron input and provide a respective neuron output.

9. The communication device of claim 1, wherein the one or more processors are configured to transform the DNN output by applying a softmax function in order to determine the plurality of decoding likelihoods.

10. The communication device of claim 1, wherein when a respective decoding likelihood of the plurality of decoding likelihoods is less than the decoding likelihood threshold, the respective decoding likelihood is set to zero.

11. The communication device of claim 1, wherein when a respective decoding likelihood of the plurality of decoding likelihoods is greater than or equal to the decoding likelihood threshold, the respective decoding likelihood is unchanged.

12. The communication device of claim 1, wherein the one or more processors are configured to encode the plurality of decoding likelihoods to a vector.

13. The communication device of claim 12, wherein the one or more processors are configured to set the maximum decoding likelihood in the vector to a non-zero value.

14. The communication device of claim 12, wherein one or more processors are configured to set non-maximum decoding likelihoods in the vector to zero.

15. A method for a communication device to determine a Modulation and Coding Scheme (MCS) index to provide in a feedback to a network, the method comprising:
providing a plurality of inputs, wherein a first subset of the plurality of inputs comprises one or more resource block inputs each comprising a post-signal-to-interference-noise-ratio (post-SINR), and wherein a second subset of the plurality of inputs comprises MCS information;
determining a plurality of outputs based on the plurality of inputs, wherein each of the plurality of outputs corresponds to a respective MCS index; and
selecting an MCS index from the plurality of outputs to provide in the feedback to the network.

16. The method of claim 15, wherein a first input of the second subset corresponds to a modulation order.

17. The method of claim 15, wherein a second input of the second subset corresponds to a coding rate.

18. One or more non-transitory computer-readable media storing instructions executable by a processor to:
receive a first subset of inputs comprising a plurality of post-signal-to-interference-noise-ratios (post-SINRs) resource blocks (RBs) and a second subset of inputs comprising modulation and coding scheme (MCS) information, and provide a deep neural network (DNN) output based on the first subset of inputs and the second subset of inputs;
provide a plurality of decoding likelihoods based on the DNN output, each decoding likelihood corresponding to an MCS index; and
determine a maximum decoding likelihood from the plurality of decoding likelihoods and select the MCS index corresponding to the maximum decoding likelihood.

19. The one or more non-transitory computer readable media of claim 18, wherein a first input of the second subset corresponds to a modulation order.

20. The one or more non-transitory computer readable media of claim 18, wherein a second input of the second subset corresponds to a coding rate.

21. (canceled)
